(19) United States
(12) Patent Application Publication
(10) Pub. No.: US 2007/0094591 A1
(43) Pub. Date: Apr. 26, 2007

(54) System and method for text legibility enhancement

(76) Inventors: Michael P. Etgen, Cary, NC (US); David J. Schell, Raleigh, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/256,710

(22) Filed: Oct. 24, 2005

(51) Int. Cl. G06F 17/00; G06F 15/00

(52) U.S. Cl. 715/522; 715/542

(57) ABSTRACT

In alternative embodiments, the invention comprises an apparatus, article, and method for modifying the properties of a style sheet having at least one rule associated with a document rendered by a display program on an output device, comprising: determining if the rule specifies a font size; comparing the font size to a legible size limit; and if the font size is less than the legible size limit, iteratively increasing the font size of the rule by a step size until the font size is greater than or equal to the legible size limit.

### FIELD OF THE INVENTION

The present invention is related generally to data processing means for formatting human-perceptible elements of electronic information for visual output. More particularly, the present invention is related to data processing means for automatically adjusting the size of text before it is rendered on a display device.

### BACKGROUND OF THE INVENTION

Many commentators around the world attribute the dawn of the “information age” to the development of wide area computer networks—particularly the Internet. Today, the Internet is a wide area network connecting thousands (if not millions) of disparate networks belonging to private industry, educational institutions, and government organizations. See, e.g., IBM Dictionary of Computing 354 (10th ed. 1993). The Internet, though, existed for many years in relative obscurity, relegated to serving the esoteric whims of academia or the highly specialized needs of the military.

It was the World Wide Web that ultimately propelled the Internet into mainstream culture. The World Wide Web, commonly known simply as “the web,” is the progeny of markup languages (more specifically, hypertext markup languages) and the Internet. The origins of the World Wide Web can be traced to a relatively simple project designed to facilitate access to electronic information scattered about in computers throughout the European Organization for Nuclear Research (CERN).

The scope of information available on the web has evolved considerably since its early days, but the core technical underpinnings have remained relatively unchanged. In short, the most basic components of the web are documents, web servers, and web browsers.

In simplest form, each document available in the web (commonly referred to as a “web page”) consists of two types of data—“content” and “code.” “Content” is the substantive information that the author of a document wants to make available to readers. Generally, content includes text and images, but also may include audio and other media. “Code” generally refers to markup language “tags” that specify the author's preference for the layout and format of the content, but also may refer to scripts and other programmable elements embedded in the document. An author may use tags to specify the format (i.e. font face, size, etc.) of each element in a document, or may use a “style sheet” to specify the format of any or all elements in a document. A style sheet is comprised of one or more “rules” that specify the properties of a given element, including the size of text elements.

The web implements a request/response architecture, wherein the web browsers request documents from the web servers, and the web servers respond by sending the data in the requested document over the network to the web browsers. When a web browser receives web page data from a web server, the web browser processes the tags in the data to determine how the content should be rendered on a display device.

It is not uncommon, though, for content to be illegible or difficult to read when the web browser renders the content on a display device. There are a variety of factors and technical nuances that can contribute to this result, but typically the problem lies in the size of the text specified by the author. Another common culprit is variation between user platforms, i.e. a user's particular browser and operating system. For example, the size specified by the author may be perfectly legible in a MOZILLA FIREFOX browser running on a LINUX operating system, while it may be virtually unreadable in a MICROSOFT INTERNET EXPLORER browser running on a MICROSOFT WINDOWS operating system. Thus, it is often difficult for an author to predict exactly how content will appear to each reader.

Web browser developers have been aware of this shortcoming for some time, and many have incorporated tools into web browsers that permit a reader to adjust the size of the text in a document after it has been rendered.

In U.S. Pat. No. 6,665,842 (issued Dec. 16, 2003), though, Nielsen observes that these tools are somewhat primitive, requiring a reader to adjust the size each time a document is rendered. Accordingly, Nielsen devised an adaptive user interface for web browsers that “utilize[s] information gathered over time to display retrieved pages with font sizes that are desired by the user, even if that user has not visited a particular page before.” While Nielsen's system shifts some of the burden from the reader, it does not remove it completely. A reader using Nielsen's system still must manually adjust the size of text at least once before Nielsen's system can “adapt” to the reader's preference. Moreover, Nielsen's system requires significant infrastructure, including several databases for storing various aspects of the user's preferences.

In an article entitled a javascript for text that's too tiny, Round describes a solution that eliminates many of the complexities of Nielsen's system, including the need for external databases. Round's solution consists of two components, both of which must be inserted into a web page by the page's author. The first component is “hidden” text, embedded in content that a web browser generally does not render on a display device. The second component is code that measures the height of the hidden text and increases the font size of the <BODY> tag if the height is too small.

Changes to the <BODY> tag, however, can have a broad (and sometimes unexpected) effect on the appearance of text in a document. Thus, solutions such as the one that Round implements often manipulate the appearance of all text without regard to the author's existing style specification.

Thus, there is a need in the art for a tool or improved web browser that can assess text legibility on a display device and modify text properties as needed to render legible text, while preserving an author's existing style specification.

### SUMMARY OF THE INVENTION

In alternative embodiments, the invention comprises an apparatus, article, and method for modifying the properties of a style sheet having at least one rule associated with a document rendered by a display program on an output device, comprising: determining if the rule specifies a font size; comparing the font size to a legible size limit; and if the font size is less than the legible size limit, iteratively increasing the font size of the rule by a step size until the font size is greater than or equal to the legible size limit.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents an exemplary network of hardware devices in which the present invention can be practiced;

FIG. 2 is a schematic of a memory having a software embodiment of the present invention stored therein;

FIG. 3 is an exemplary embodiment of a style sheet, with which an embodiment of the present invention interacts;

FIG. 4 is a flowchart of an embodiment of the present invention; and

FIG. 5 is a code listing of an embodiment of the present invention.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “text legibility enhancement” program (TLEP).

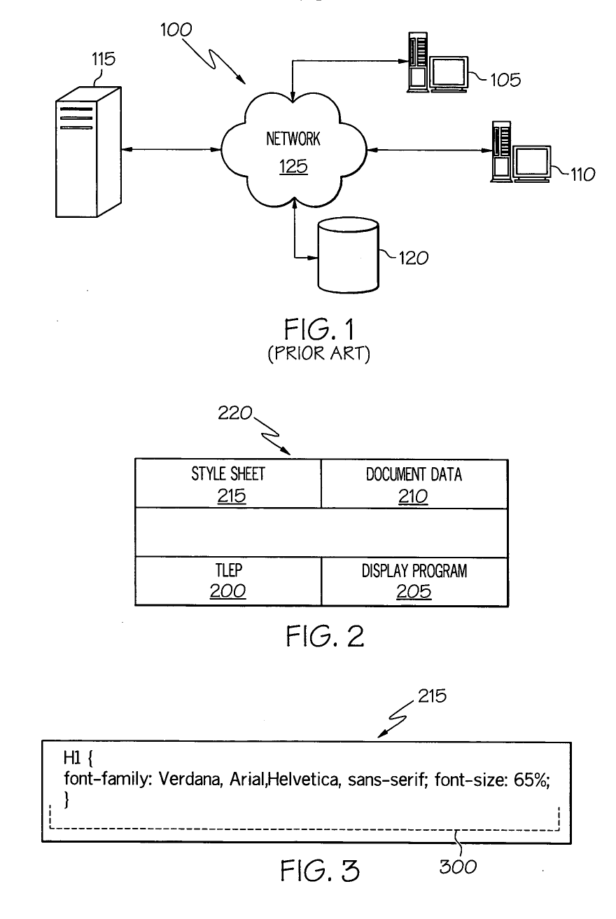

Additionally, the TLEP is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

TLEP 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media and network nodes. Thus, FIG. 2 is included merely as a descriptive expedient and does not necessarily reflect any particular physical embodiment of memory 220. As depicted in FIG. 2, though, memory 220 may include additional data and programs. Of particular import to TLEP 200, memory 220 may include display program 205, document 210, and style sheet 215, with which TLEP 200 interacts.

Document 210 represents any block of data having content and code. In this context, “content” is substantive information that the author of a document wants to make available to readers. “Code” generally refers to markup language tags that specify the author's preference for the layout and format of the content, but also may refer to scripts and other programmable elements embedded in a document. A web page is an exemplary embodiment of document 210.

Style sheet 215 represents any data comprised of one or more rules that specify the format of any or all elements in a document. A cascading style sheet used with web pages is an exemplary embodiment of style sheet 215.

Display program 205 represents any software that renders a document on an output device. A web browser is an exemplary embodiment of display program 205. In practice, TLEP 200 may be embedded in document 210, or may be integrated into display program 205.

TLEP 200 assesses and modifies the text properties of content rendered by a web browser on a display device so that the text is legible to a user. In general, the text properties are specified by style sheet 215, which may be embedded in document 210 or included by reference to an external document. More than one style sheet may be associated with a single document, but the following discussion assumes that only one style sheet 215 is associated with document 210 and that style sheet 215 is an external document included in document 210 by reference. TLEP 200 determines if a rule in the style sheet specifies a font size; compares the font size to a legible size limit; and if the rule font size is less than the legible size limit, incrementally increases the font size until the font size is greater than or equal to the legible size limit.

FIG. 3 is an exemplary embodiment of style sheet 215. In this example, style sheet 215 is a Cascading Style Sheet (CSS), the type of which is used commonly with web pages. This exemplary style sheet 215 has only a single rule (rule 300), which specifies the font family and font size for H1 elements (a top level heading in a web page). Of course, those skilled in the art will appreciate that style sheets typically have more than one such rule, and that rule 300 is merely illustrative. Moreover, the font size in exemplary style sheet 215 is specified as a percentage of a default font size, but those skilled in the art will appreciate that an author may specify font sizes with other measurements, including without limitation em units and pixels.

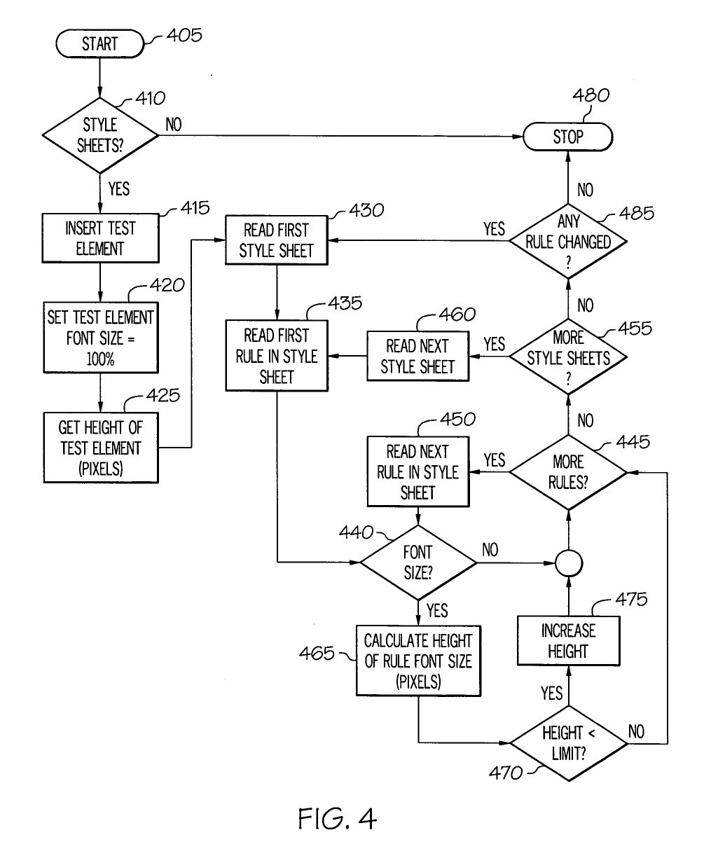

FIG. 4 is a flowchart illustrating the logic of an embodiment of TLEP 200. In FIG. 4, TLEP 200 starts (405) when display program 205 loads document 210. TLEP 200 first determines if any style sheets are associated with document 210 (410). TLEP then inserts a test element (415) into document 210. The test element can be any type of element, but preferably is hidden from the user. In a web page, an exemplary test element is a <DIV> element having a single space character. TLEP 200 sets the font size of the test element to 100% of the default font size (420) and determines the height of the test element (425), measured in pixels. TLEP 200 then reads the first style sheet (430) associated with document 210. Next, TLEP 200 reads the first rule of the first style sheet (435) and determines if the rule specifies a font size (440). If the first rule does not specify a font size, TLEP 200 determines if the first style sheet has any more rules (445), and iteratively checks each rule (450) in the first style sheet to determine if the rule specifies a font size (440). Likewise, if the first style sheet does not contain any rules that specify a font size, TLEP 200 determines if any more style sheets are associated with document 210 (455), and iteratively checks each style sheet (460) to determine if any rule in any other style sheet specifies a font size (435-460).

For each rule that specifies a font size, TLEP 200 calculates the height of an element having the specified font size (465) and compares this height to a legible size limit (470). A legible size limit of approximately 10 pixels has been found to be satisfactory for most circumstances. Accordingly, TLEP 200 fixes the legible size limit at 10 pixels, but this limit may be configured by a programmer or user to meet varying needs.

If TLEP 200 determines that a font size specified in a rule is less than the legible size limit, then TLEP 200 increases the font size that the rule specifies (475) by a configurable step size. The step size may be manipulated to achieve a desired balance between performance and control. When a rule specifies a font size as a percentage of a default font size, as in rule 300 of exemplary style sheet 215, a step size of 5%-10% of the font size has been found to produce an acceptable balance. Of course, when a rule specifies a font size in an alternate form, such as em units, an alternate form of step size is appropriate.

Thus, as FIG. 4 illustrates, TLEP 200 iteratively increases the font size of each rule in each style sheet until each rule has a font-size that is greater than or equal to the legible size limit. TLEP 200 stops (480) when no rule needs modification (485).

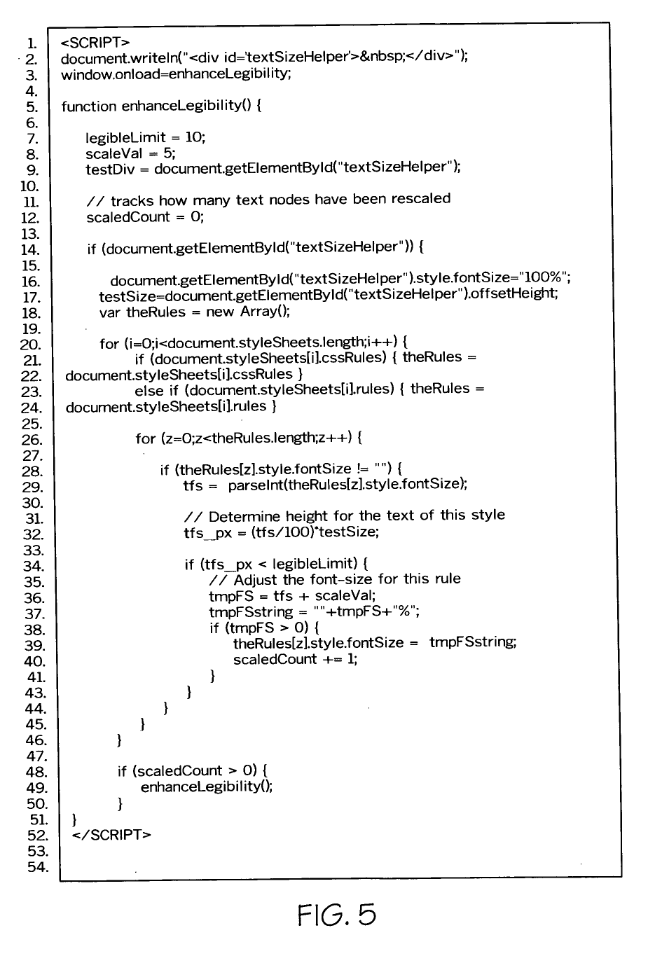

FIG. 5 illustrates a JAVASCRIPT embodiment of TLEP 200, which implements the logic of the flowchart in FIG. 4. Referring to FIGS. 4 & 5 for illustration, line 2 inserts a test element (415) into a document. Line 7 sets the legible size limit to 10 pixels, and line 8 sets the incremental step size to 5%. Line 16 sets the font size of the test element to 100% of the default font size (420), and line 17 determines the height of the test element (425) at a font size of 100%. Then, line 28 determines if a rule specifies a font size (440), and if so, line 31 calculates the height of an element having the specified font size (465). In this embodiment, TLEP 200 assumes that the font size is specified as a percentage of the default, but those skilled in the art should appreciate the applicability to other measurements of font size, including em units and pixel units. Given a font size specified as a percentage, though, line 32 calculates the height by first calculating the ratio of the specified font size to the test element font size, and then multiplying the ratio by the height of the test element. Line 34 then determines if the height of the font size that the rule specifies is less than the legible size limit (470). Lines 36-37 increase the specified font size by the incremental step size (475) if the height is less than the legible size limit. Line 40 sets a flag to indicate that TLEP 200 modified at least one rule associated with the document. TLEP 200 loops through each style sheet until all rules have been processed (see lines 20 & 26). Finally, line 48 checks the flag to determine if any rules have been modified (475). If any rules have been modified, line 49 recursively invokes TLEP 200 to repeat the processing.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer-implemented method for modifying the properties of a style sheet having at least one rule associated with a document rendered by a display program on an output device, the method comprising:
determining if the rule specifies a font size;
comparing the font size to a legible size limit; and
if the font size is less than the legible size limit, iteratively increasing the font size of the rule by a step size until the font size is greater than or equal to the legible size limit.

2. The method of claim 1 wherein the legible size limit is a minimum height, and the step of comparing the font size to the legible size limit comprises:
converting the font size to a height; and
comparing the height to the minimum height.

3. The method of claim 2 wherein the font size is a rule font size, the document has a default font size, and the step of converting the rule font size to a height comprises:
inserting a test element into the document, the test element having a test font size;
setting the test font size to 100% of the default font size;
converting the test font size into a test height;
calculating the ratio of the rule font size to the test font size; and
multiplying the ratio by the test height;
wherein the result of the multiplying step is the height of the rule font size.

4. The method of claim 1 wherein the legible size limit is greater than or equal to 10 pixels.

5. The method of claim 1 wherein the step size is less than 10% of the font size.

6. The method of claim 1 wherein the document is a web page and the display program is a web browser program.

7. A computer-readable memory having a computer program for performing a method of modifying the properties of a style sheet having at least one rule associated with a document rendered by a display program on an output device, the method comprising:
determining if the rule specifies a font size;
comparing the font size to a legible size limit; and
if the font size is less than the legible size limit, iteratively increasing the font size of the rule by a step size until the font size is greater than or equal to the legible size limit.

8. The memory of claim 7 wherein the legible size limit is a minimum height, and the step of comparing the font size to the legible size limit comprises:
converting the font size to a height; and
comparing the height to the minimum height.

9. The memory of claim 8 wherein the font size is a rule font size, the document has a default font size, and the step of converting the rule font size to a height comprises:
inserting a test element into the document, the test element having a test font size;
setting the test font size to 100% of the default font size;
converting the test font size into a test height;
calculating the ratio of the rule font size to the test font size; and
multiplying the ratio by the test height;
wherein the product of the multiplying step is the height of the rule font size.

10. The memory of claim 7 wherein the legible size limit is greater than or equal to 10 pixels.

11. The memory of claim 7 wherein the step size is less than 10% of the font size.

12. The memory of claim 7 wherein the document is a web page and the display program is a web browser program.

13. A computer comprising:
a processor;
a memory coupled to the processor;
an output device coupled to the processor;
a document in the memory;
a style sheet in the memory, the style sheet having at least one rule associated with the document;
a display program in the memory, the display program comprising instructions for causing the processor to render the document on the output device; and
a text legibility enhancement program in the memory, the text legibility enhancement program comprising instructions for causing the processor to
determine if the rule specifies a font size;
compare the font size to a legible size limit; and
if the font size is less than the legible size limit, iteratively increase the font size of the rule by a step size until the font size is greater than or equal to the legible size limit.

14. The computer of claim 13 wherein the legible size limit is a minimum height, and the instructions for causing the processor to compare the font size to the legible size limit comprise instructions for causing the processor to:
convert the font size to a height; and
compare the height to the minimum height.

15. The computer of claim 14 wherein the font size is a rule font size, the document has a default font size, and the instructions for causing the processor to convert the rule font size to a height comprise instructions for causing the processor to:
insert a test element into the document, the test element having a test font size;
set the test font size to 100% of the default font size;
convert the test font size into a test height;
calculate the ratio of the rule font size to the test font size; and
multiply the ratio by the test height;
wherein the product of the multiplication is the height of the rule font size.

16. The computer of claim 13 wherein the legible size limit is greater than or equal to 10 pixels.

17. The computer of claim 13 wherein the step size is less than 10% of the font size.

18. The computer of claim 13 wherein the document is a web page and the display program is a web browser program.
